(19) United States
(12) Patent Application Publication
(10) Pub. No.: US 2015/0362918 A1
(43) Pub. Date: Dec. 17, 2015

(54) Method of Operating a Remotely Accessible Unmanned Underwater Vehicle

(71) Applicant: Jared Hughes Morris, Montgomery, AL (US)

(72) Inventor: Jared Hughes Morris, Montgomery, AL (US)

(21) Appl. No.: 14/740,014

(22) Filed: Jun. 15, 2015

Related U.S. Application Data
(60) Provisional application No. 62/011,671, filed on Jun. 13, 2014.

(51) Int. Cl. G05D 1/00; G01C 21/00; B63G 8/00

(52) U.S. Cl. CPC G05D 1/0038; B63G 8/001; G01C 21/00; B63G 2008/005

(57) ABSTRACT

A method of providing operating access to remotely accessible unmanned underwater vehicles (UUVs) utilizes a plurality of UUVs, a remote relay devices, and a computer relay system communicably coupled to an end-user computing device by a telecommunications network. The end-user enters preferences for a UUV selection. The preferences are compared to UUV characteristics and current operability conditions of the UUVs to identify a compatible vehicle from the UUVs. Live visual data is then streamed from a camera on the compatible vehicle over the telecommunications network to the end-user device, and the end user assumes remote control of the compatible vehicle by sending navigation commands to the compatible vehicle through the computer relay system, which are executed by the compatible vehicle.

The current application claims a priority to the U.S. Provisional Patent application Ser. No. 62/011,671 filed on Jun. 13, 2014. The current application is filed on Jun. 15, 2015, whereas Jun. 13, 2015 and Jun. 14, 2015 were on a weekend.

### FIELD OF THE INVENTION

The present invention relates generally to remote control vehicles. More particularly, the present invention relates to remotely accessing and controlling unmanned underwater vehicles.

### BACKGROUND OF THE INVENTION

The present invention relates generally to unmanned underwater vehicles (“UUVs,” or “submersibles”), which can be operated remotely through devices wirelessly linking the submersible's control system to a remote operating device. The remote operating device allows a human operator to input operating and maneuvering instructions to the submersible, and it also provides output to the human operator reflecting the location, video and audio feed, or other status of the submersible. UUVs allow, among other things, the opportunity to explore the oceans and other bodies of water on the planet without assuming the hazards and difficulties of underwater submersion by the human operator/explorer herself.

UUVs can be controlled remotely. Conventional UUVs are accessed and operated by a specific operator or group of operators from a specific remote operating device, or “access point.” With current technology, operators must physically travel to a specific access point near or on a body of water in order to operate a UUV. The present invention instead allows remote access and operation of a UUV not from a specific access point but rather from any access point available through the internet or a similar telecommunications network. In other words, this invention leverages the internet or another telecommunications network to provide unparalleled convenience, safety, flexibility, and efficiency for the selection, accessing, and operation of UUVs.

The intention for the present invention is to enable members of the global public to explore the oceans and other bodies of water on the planet from their laptops, smart phones, and similar devices, for purposes of research, education, commerce, industry, or (last but not least) pure recreation.

### BRIEF DESCRIPTION OF THE DRAWINGS

FIG. 1 is a block diagram of the system to be used in the present invention.

FIG. 2 is a stepwise flow diagram describing the general process of the present invention.

FIG. 3 is a stepwise flow diagram describing additional steps for electronic communication between UUVs and the end user computing device.

FIG. 4 is a stepwise flow diagram describing steps for designating one of the plurality of UUVs for the end user to operate.

FIG. 5 is a stepwise flow diagram describing steps for returning a UUV to a charging location.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a method of accessing and operating a remotely accessible unmanned underwater vehicle. The present invention takes advantage of a network and system in order to provide the opportunity to remotely operate a UUV through devices wirelessly linking a remote operating device to a control system of the UUV in order to provide end users the opportunity to remotely explore aquatic environments.

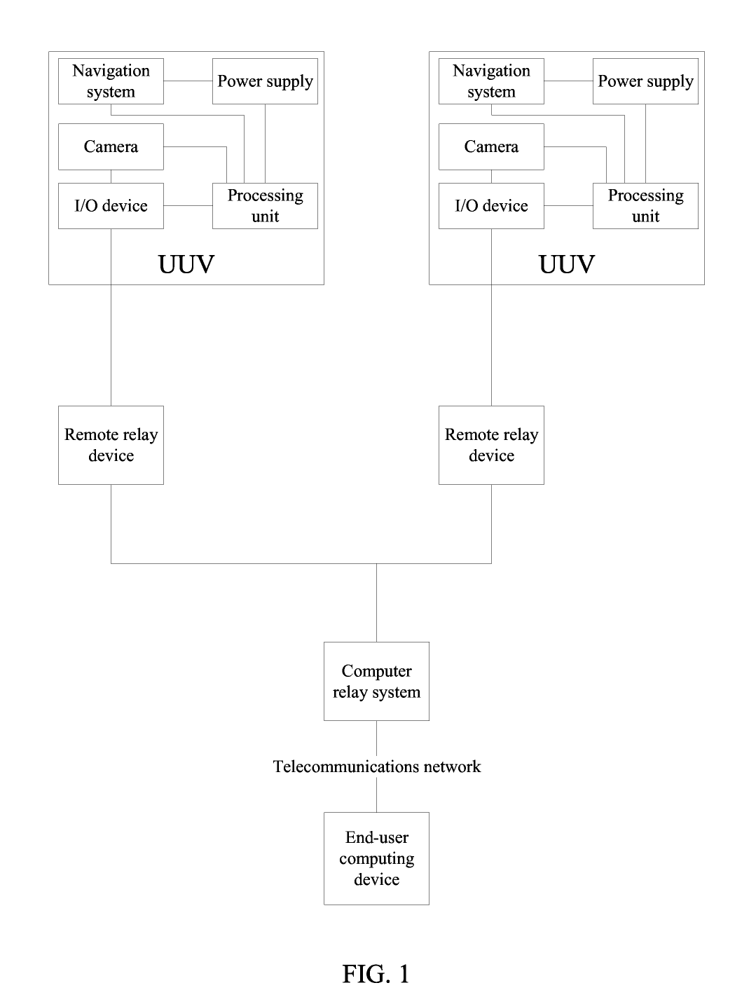

Referring to FIG. 1, the system in the preferred embodiment of the present invention comprises, but is not limited to, a plurality of UUVs, a remote relay device, and a computer relay system. Each of the plurality of UUVs comprises a processing unit, an input/output (I/O) device, a navigation system, and a power supply. Each of the plurality of UUVs is electronically connected to the computer relay center through a telecommunications network. The telecommunications network may be established through any relevant or useful means in order to allow communication between the UUVs and the computer relay system. Herein, the telecommunications network should be understood to include any number of individual connections required to interface the UUVs with the computer relay system, and the telecommunications network may include any relevant type of electronic communication.

The I/O device and the navigation system of the UUVs are electronically connected to the processing unit, and the processing unit and the navigation system are electronically connected to the power supply. Each of the UUVs may utilize any currently known or new form of technology or apparatus to allow underwater navigation, video and audio capture, power and wireless communication for the facilitation of the present invention. The I/O device is a component of the UUVs that allows transmission of input and output information to and from the UUVs. The I/O device facilitates communication between the processing unit of the UUV and other external processing systems. In the preferred embodiment of the present invention, the I/O device additionally comprises or interfaces with an optical capture device (camera) of the UUV and an audio capture device of the UUV. The camera is essential to the present invention since the intention is to provide end users a chance to visually navigate through aquatic environments. The audio capture device is optional but may enhance the user experience. In the preferred embodiment of the present invention, the power supply of the UUVs is a rechargeable battery. In alternative embodiments, the power supply may comprise a solar panel or a physical power cable, however this limits the range and maneuverability of the UUVs.

The remote relay device acts as a waypoint between one or more UUVs and the computer relay system. As such, the remote relay device is electronically connected to at least one UUV from the plurality of UUVs and to the computer relay system. The remote relay device comprises a telecommunications transceiver or any other device that allows the remote relay device to access and communicate with a telecommunications network. In one embodiment, the remote relay device may be physically tethered to a telecommunications network by a cable. In the preferred embodiment however, the remote relay device is able to communicate with a telecommunications network through a wireless transceiver as is common in mobile telecommunications applications. Since water severely impedes wireless electronic communication, the signals being transmitted to and from a UUV cannot be transmitted over great distances and must be amplified by a relay device within range to accept and transmit signals without significant signal loss. The remote relay device may take any number of useful forms to achieve this purpose. For example, the remote relay device may be a buoy located on a body of water. However, it is contemplated that technology or techniques may evolve to allow signals strong enough to wirelessly interface directly with the computer relay system through telecommunications network without requiring a relay device in the vicinity of a UUV. The preferred embodiment of the present invention includes the remote relay device and the current application is written as such, though it should be understood that the remote relay device may be omitted if possible.

The computer relay system is the main operation entity of the present invention. The computer relay system must comprise at least one computing device capable of executing the main computer-executable instructions including programming language code and logic required for the present invention to operate. The computer relay system is connected to the telecommunications network, and an end user interfaces with the computer relay system through the telecommunications network (specifically, from the end-user's standpoint, the Internet). The computer relay system functions as the “brain” of the present invention.

Each of the UUVs is electronically connected to one of a plurality of remote relay devices, and each of the remote relay devices is electronically connected to the computer relay center through the telecommunications network. Any given UUV must be physically positioned within range of one of the remote relay devices for the given UUV to be able to function in the present invention. To allow an end user choice of location and type of aquatic environment to explore, UUVs and corresponding remote relay devices may be distributed to a number of different geographical locations. The location of any given UUV and remote relay station combinations in the present invention depends solely on access to a telecommunications network.

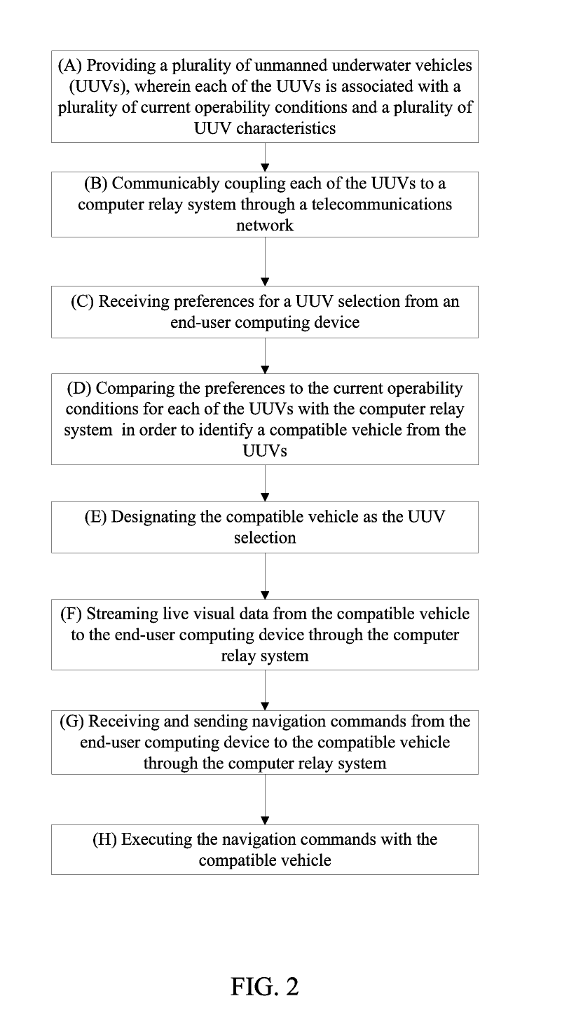

Referring to FIG. 2, in the general process of operating the UUVs of the present invention, each of the UUVs is associated with a plurality of UUV characteristics and a plurality of current operability conditions. The current operability conditions reflect the current viability of an end user gaining control of one of the UUVs through the present invention based on several factors including functionality of the UUVs, weather conditions, distance, whether a given UUV is currently in use, and preferences expressed by an end user making a request to pilot a UUV.

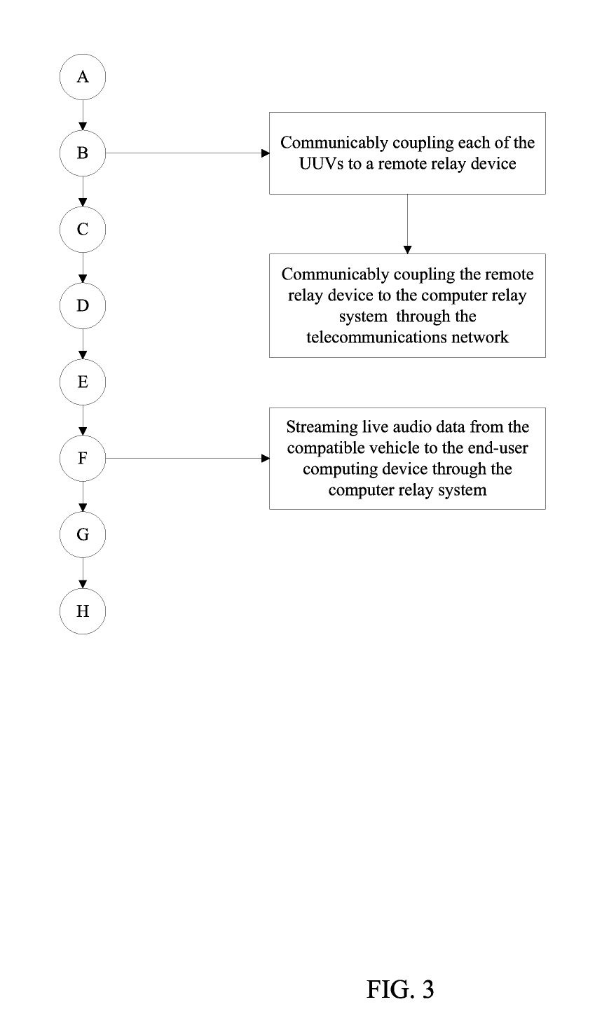

Each of the UUVs is communicably coupled to the computer relay system through the telecommunications network. In the preferred embodiment as described in FIG. 3, each of the UUVs is coupled to one of the remote relay devices, and each of the remote relay devices is communicably coupled to the computer relay system through the telecommunications network. Preferences for a UUV selection are received from an end-user computing device. The preferences are compared to the current operability conditions for each of the UUVs with the computer relay system in order to identify a compatible vehicle from the UUVs. The compatible vehicle is designated as the UUV selection, once the compatible vehicle is found according to the current operability conditions. The end-user is then provided with control of the compatible vehicle. Live visual data is streamed from the compatible vehicle to the end-user computing device through the computer relay system and the remote relay device over the telecommunications network. In one embodiment, live audio data is also streamed from the compatible vehicle to the end-user computing device through the computer relay system. Navigation commands are received and sent from the end-user computing device to the compatible vehicle through the computer relay system, and the navigation commands are executed with the compatible vehicle.

The preferences submitted by the end-user are compared to the UUV characteristics of each of the UUVs, and relevant UUVs are chosen from the plurality of UUVs, wherein the relevant UUVs match the preferences. If no relevant UUVs are found, the end-user is prompted to resubmit the preferences. In one embodiment of the present invention, the end-user must select from a predetermined list in order to submit the preferences.

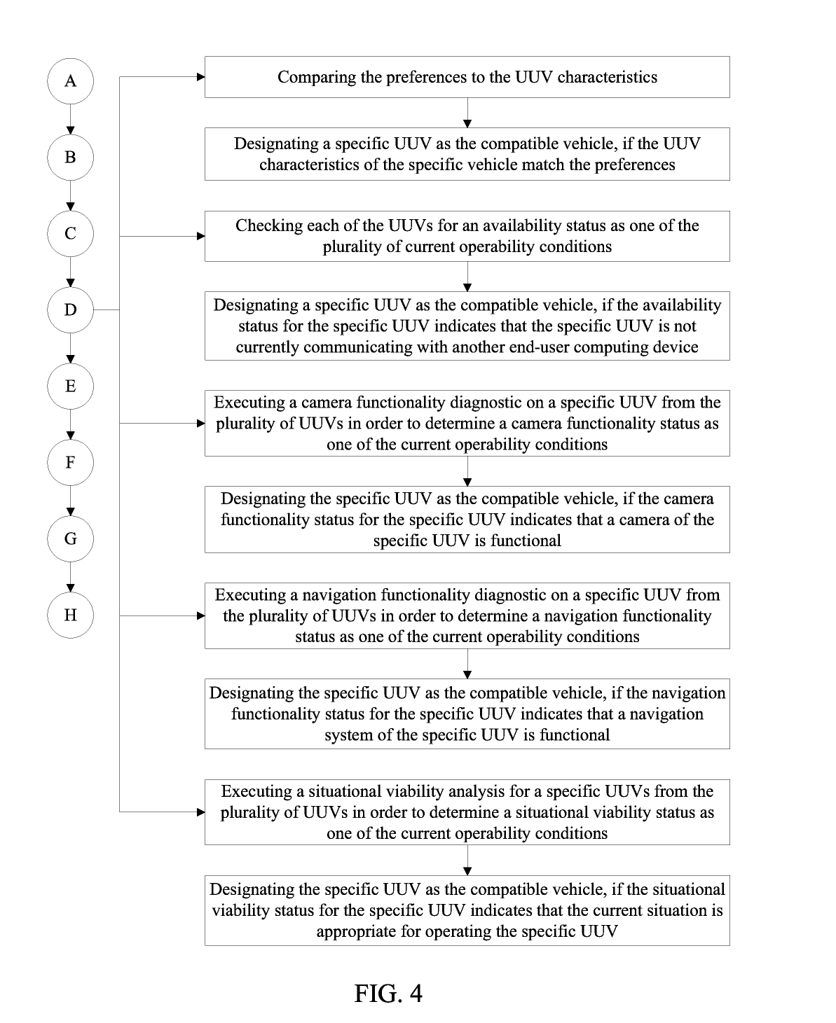

In reference to FIG. 4, a number of analyses are executed on each of the UUVs in order to determine the status of the current operability conditions. Each of the UUVs is checked for an availability status as one of the plurality of current operability conditions. In order for a specific UUV to be chosen as the compatible vehicle, a camera functionality diagnostic is executed on the specific UUV, in order to determine a camera functionality status as one of the current operability conditions. A navigation functionality diagnostic is executed on the specific UUV in order to determine a navigation functionality status as one of the current operability conditions. A situational viability analysis is executed for the specific UUV in order to determine a situational viability status as one of the current operability conditions. In one embodiment of the present invention, said analyses are performed continually or intermittently in order to keep a continually updated status for each of the UUVs, or the analyses are performed when the preferences are received from the end-user, or both.

If the UUV characteristics of the specific UUV matches the preferences, if the availability status for the specific UUV indicates that the specific UUV is not currently in communication with another end-user device, if the camera functionality status for the specific UUV indicates the camera of the specific UUV is functional, if the navigation functionality status for the specific UUV indicates that the navigation system is functional, and if the situational viability status for the specific UUV indicates that the current situation is appropriate for operating the specific UUV, the specific UUV is designated as the compatible vehicle, and the end-user is granted control of the specific UUV.

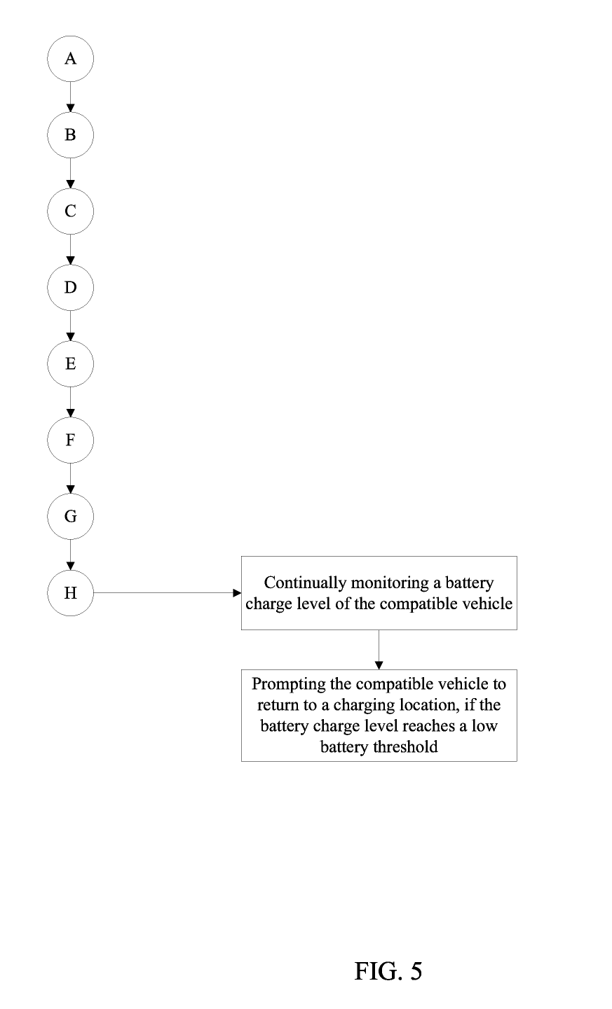

In one embodiment referenced in FIG. 5, a battery charge level is continually monitored for the compatible vehicle, and the compatible vehicle is prompted to return to a charging location if the battery charge level reaches a low battery threshold.

Although the invention has been explained in relation to its preferred embodiment, it is to be understood that many other possible modifications and variations can be made without departing from the spirit and scope of the invention as hereinafter claimed.

What is claimed is:

1. A method of providing operating access to remotely accessible unmanned underwater vehicles comprises the steps of:
providing a plurality of unmanned underwater vehicles (UUVs), wherein each of the UUVs is associated with a plurality of current operability conditions and a plurality of UUV characteristics;
communicably coupling each of the UUVs to a computer relay system through a telecommunications network;
receiving preferences for a UUV selection from an end-user computing device;
comparing the preferences to the current operability conditions for each of the UUVs with the computer relay system in order to identify a compatible vehicle from the UUVs;
designating the compatible vehicle as the UUV selection;
streaming live visual data from the compatible vehicle to the end-user computing device through the computer relay system;
receiving and sending navigation commands from the end-user computing device to the compatible vehicle through the computer relay system; and
executing the navigation commands with the compatible vehicle.

2. A method of providing operating access to remotely accessible unmanned underwater vehicles as claimed in claim 1 comprises the steps of:
communicably coupling each of the UUVs to a remote relay device; and
communicably coupling the remote relay device to the computer relay system through the telecommunications network.

3. A method of providing operating access to remotely accessible unmanned underwater vehicles as claimed in claim 1 comprises the step of:
streaming live audio data from the compatible vehicle to the end-user computing device through the computer relay system.

4. A method of providing operating access to remotely accessible unmanned underwater vehicles as claimed in claim 1 comprises the steps of:
comparing the preferences to the UUV characteristics; and
designating a specific UUV as the compatible vehicle, if the UUV characteristics of the specific UUV match the preferences.

5. A method of providing operating access to remotely accessible unmanned underwater vehicles as claimed in claim 1 comprises the steps of:
checking each of the UUVs for an availability status as one of the plurality of current operability conditions; and
designating a specific UUV as the compatible vehicle, if the availability status for the specific UUV indicates that the specific UUV is not currently communicating with another end-user computing device.

6. A method of providing operating access to remotely accessible unmanned underwater vehicles as claimed in claim 1 comprises the steps of:
executing a camera functionality diagnostic on a specific UUV from the plurality of UUVs in order to determine a camera functionality status as one of the current operability conditions; and
designating the specific UUV as the compatible vehicle, if the camera functionality status for the specific UUV indicates that a camera of the specific UUV is functional.

7. A method of providing operating access to remotely accessible unmanned underwater vehicles as claimed in claim 1 comprises the steps of:
executing a navigation functionality diagnostic on a specific UUV from the plurality of UUVs in order to determine a navigation functionality status as one of the current operability conditions; and
designating the specific UUV as the compatible vehicle, if the navigation functionality status for the specific UUV indicates that a navigation system of the specific UUV is functional.

8. A method of providing operating access to remotely accessible unmanned underwater vehicles as claimed in claim 1 comprises the steps of:
executing a situational viability analysis for a specific UUVs from the plurality of UUVs in order to determine a situational viability status as one of the current operability conditions; and
designating the specific UUV as the compatible vehicle, if the situational viability status for the specific UUV indicates that the current situation is appropriate for operating the specific UUV.

9. A method of providing operating access to remotely accessible unmanned underwater vehicles as claimed in claim 1 comprises the steps of:
continually monitoring a battery charge level of the compatible vehicle; and
prompting the compatible vehicle to return to a charging location, if the battery charge level reaches a low battery threshold.
